(19) United States
(12) Patent Application Publication
(10) Pub. No.: US 2015/0233459 A1
(43) Pub. Date: Aug. 20, 2015

(54) CAM FOLLOWER OR ECCENTRIC FOLLOWER WITH ROLLER SUPPORTED BY PLAIN BEARING MOUNTING

(71) Applicant: Schaeffler Technologies AG & Co. KG, Herzogenaurach (DE)

(72) Inventors: Stefan Dupke, Kodnitz (DE); Alexander Waldo, Furth (DE); Frank Schlerege, Herzogenaurach (DE)

(73) Assignee: Schaeffler Technologies AG & Co. KG, Herzogenaurach (DE)

(21) Appl. No.: 14/620,560

(22) Filed: Feb. 12, 2015

(30) Foreign Application Priority Data
Feb. 14, 2014 (DE) 102014202694.6

(51) Int. Cl. F16H 53/06; F01L 1/14

(52) U.S. Cl. CPC F16H 53/06; F01L 1/14

(57) ABSTRACT

A component constructed as a cam follower or eccentric follower, such as a finger follower, swinging arm, or rocker arm or tappet for gas-exchange valves or pumps of reciprocating internal combustion engines is provided, with a roller (2) that is guided on a pin (1) and is in active connection with a cam lobe or eccentric of a camshaft or a sliding cam of the internal combustion engine. The roller (2) is arranged on the pin (1) via a plain bearing mounting and the ratio of the plain bearing mounting width to the plain bearing mounting diameter is selected in the range of between approximately 0.4 to 0.8.

### INCOPORATION BY REFERENCE

The following documents are incorporated herein by reference as if fully set forth: German Patent Application No. 102014202694.6, filed Feb. 14, 2014.

### BACKGROUND

The invention relates to a component constructed as a cam follower or eccentric follower, such as a finger follower, pivot lever, or rocker arm or tappet for gas-exchange valves or pumps of reciprocating internal combustion engines, with a roller that is arranged on a pin and is in active connection with a cam disk or eccentric of a camshaft or a sliding cam of the internal combustion engine.

A cam follower that is constructed as a finger follower is known from DE 10 2004 002 290 A1. The roller is guided by rolling bodies on an inner ring that is arranged on the pin, wherein the roller forms the bearing outer ring.

The cam follower of DE 10 2009 013 131 A1, constructed as a tappet, has a roller that is guided by rolling bodies on the pin, wherein the roller forms the bearing outer ring and the rolling bodies correspond to the pin.

For the plain bearing mounting of a roller on the pin, the radial bearing play is an important design criterion. It has an effect on the parameters of lubricating film height, generated bearing friction, and also pressure distribution in the plain bearing mounting. Varying the bearing play by a few tenths of a percent of the bearing diameter causes a significant change in the parameters noted above.

Therefore, the bearing play must be specified as exactly as possible. For a roller arrangement that is supported with plain bearing mountings, formed from a pin, optional inner ring, outer ring, and roller, this concerns the outer diameter tolerance of the pin or inner ring and the inner diameter tolerance of the outer ring or the roller. The necessary restriction of the production tolerances increases the production costs for the roller arrangement. If the production tolerances are not narrowed and the “production-typical” tolerance is permitted, the parameters of lubrication film height, generated bearing friction, and pressure distribution can be made significantly worse as a function of the selected width to diameter ratio of the plain bearing mounting. Here, an increase of the bearing play to “production-typical” tolerances can lead to increased bearing friction and higher loading.

In addition to the production tolerances, the smoothing of the surfaces that can occur during operation of the plain bearing mounting act on the bearing play. An increase in bearing play due to smoothing in the contact surfaces can also have a negative effect on the friction and the wear behavior.

### SUMMARY

The object of the invention is to improve the plain bearing mounting of the roller arrangement such that the described disadvantages are avoided. The plain bearing mounting should be producible in an economical way and should not be sensitive to fluctuations in the bearing play. Here, the parameters of lubrication film height, generated bearing friction, and pressure distribution should have the most tolerant possible response to fluctuations in the bearing play.

According to the invention, the objective is met in that, for plain bearing mounting of the roller on the pin, the ratio of the plain bearing mounting width to the plain bearing mounting diameter is selected in the range between approx. 0.4 and 0.8. It has turned out, namely, that the width to diameter ratio of the plain bearing mounting plays a decisive role. Advantageously, this ratio is in the range from 0.5 to 0.7. Then the bearing has a particularly insensitive response to an increase in the bearing play. The use of “production-typical” tolerances causes a relatively small change in the parameters of lubrication film height, generated bearing friction, and pressure distribution in the bearing. It behaves accordingly with the increase of the bearing play due to smoothing in the contact surfaces during operation.

In another construction of the invention it is provided that the roller is formed as an outer ring and the pin is formed as an inner ring of the plain bearing mounting. This produces a compact and economical construction of the bearing.

Alternatively, a plain bearing mounting outer or inner ring could be arranged locked in rotation in the roller and/or on the pin. In this way it is possible to select different materials adapted to the required operating conditions for the plain bearing mounting rings and the roller and the pin.

To define the sliding surface of the bearing exactly, it is provided that the pin is guided on the component in an axially fixed and/or rotationally locked way.

### BRIEF DESCRIPTION OF THE DRAWINGS

The invention is described in the drawings:

FIG. 1 shows a perspective view of a pin with roller as an outer ring,

FIG. 2 shows a cross section of a pin with roller, and

FIG. 3 shows a side view similar to FIG. 1 with width and diameter dimensions.

### DETAILED DESCRIPTION OF THE PREFERRED EMBODIMENTS

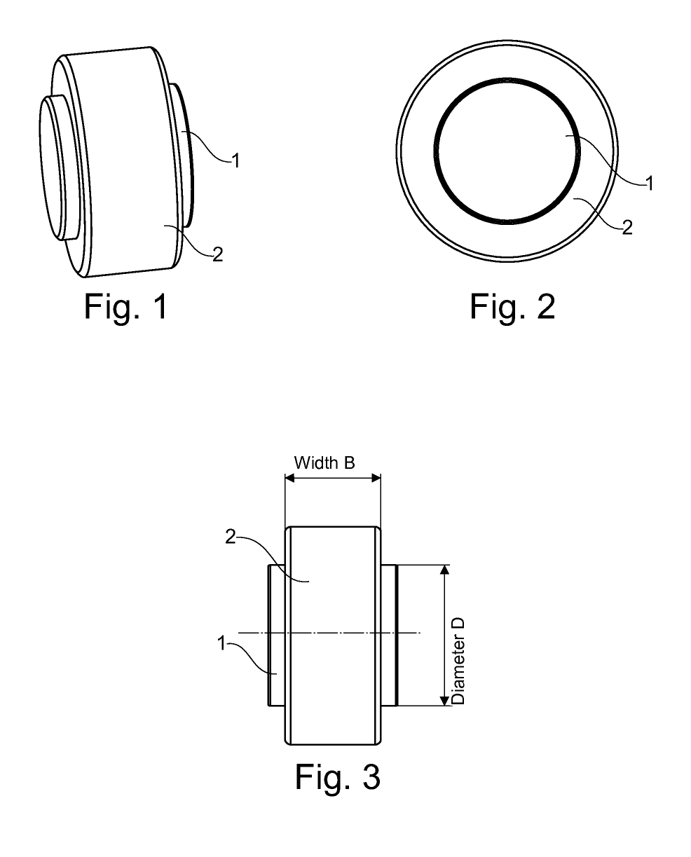

In FIGS. 1 to 3, 1 designates a pin that is arranged locked in rotation on a component of a cam follower or eccentric follower, such as a finger follower, pivot lever, or rocker arm or a tappet of a reciprocating piston internal combustion engine. The cam follower or eccentric follower is typically arranged in a space that is wetted with oil or impinged upon by splash oil, so that adequate oil lubrication is ensured. However, a targeted oil supply can also be provided via a pressurized line. A roller designated with 2 is supported on the pin 1, wherein this bearing is constructed as a plain bearing mounting, the roller 2 forms the outer ring, and the pin 1 forms the inner ring of the bearing. The roller 2 is in active connection with the cam lobes or eccentric, not shown, of a camshaft or a sliding cam and rolls on these. Here, the width of the roller or the effective width of the roller as a bearing outer ring to the diameter of the pin has a ratio of 0.5 to 0.7. Therefore it is possible to provide a simple, economical plain bearing mounting that is relatively tolerant relative to oscillations of the bearing play.

1. A cam follower or eccentric follower, comprising: a roller that is guided on a pin and is in active connection with a cam lobe or eccentric of a camshaft or a sliding cam of an internal combustion engine, a plain bearing mounting between the roller and the pin by which the roller is guided, and a ratio of a plain bearing mounting width to a plain bearing mounting diameter is selected to be in a range between approx. 0.4 to 0.8.

2. The cam follower or eccentric follower according to claim 1, wherein the ratio is between 0.5 to 0.7.

3. The cam follower or eccentric follower according to claim 1, wherein the roller is constructed as an outer ring and the pin is constructed as an inner ring of the plain bearing mounting.

4. The cam follower or eccentric follower according to claim 3, wherein one of the plain bearing mounting outer ring or the inner ring is arranged locked in rotation in the roller or on the pin.

5. The cam follower or eccentric follower according to claim 1, wherein the pin is guided on the cam follower or eccentric follower at least one of fixed in an axial direction or locked in rotation.

6. The cam follower or eccentric follower according to claim 1, wherein the cam follower or eccentric follower is a finger follower, pivot lever, rocker arm, or tappet for gas-exchange valves or pumps of reciprocating internal combustion engine.
